(19) United States
(12) Patent Application Publication
(10) Pub. No.: US 2016/0380457 A1
(43) Pub. Date: Dec. 29, 2016

(54) CHARGER FOR MOBILE DEVICE

(71) Applicant: JEAN CRISS MEDIA LLC, New Providence, NJ (US)

(72) Inventor: Jean Criss, Springfield, NJ (US)

(21) Appl. No.: 15/191,276

(22) Filed: Jun. 23, 2016

Related U.S. Application Data
(60) Provisional application No. 62/183,494, filed on Jun. 23, 2015.

(51) Int. Cl. H02J 7/00

(52) U.S. Cl. CPC H02J 7/0045; H02J 7/0027

(57) ABSTRACT

A charger for a mobile device includes a housing having a first end, a second end, a hollow interior compartment. The second end includes a first opening and a pair of first slots that accommodate a foldable plug that is disposed within the hollow interior compartment and is pivotally coupled to the housing. The foldable plug is movable between an extended position in which prongs thereof lie outside of the housing and a fully retracted position in which the foldable plug lies within the pair of first slots. The charger includes electronics contained within the housing and a spring biased winder mounted to housing and disposed within the hollow interior compartment. An extendable/retractable cord is connected at one end to a connector and at an opposite end is electrically connected to the foldable plug and is wound about the spring biased winder. The first end of the housing is configured such that the connector and cable are contained and held in a recessed portion formed therein.

### CROSS-REFERENCE TO RELATED PATENT APPLICATIONS

This application is based on and claims priority to U.S. Provisional Patent Application 62/183,494, filed Jun. 23, 2015, the entire contents of which is incorporated by reference herein as if expressly set forth in its respective entirety herein.

### TECHNICAL FIELD

The present invention relates to electrical chargers and more particularly, to a compact charger for a mobile device.

### BACKGROUND

In recent years, mobile devices have become mainstream and are increasingly a part of everyday life. As mobile devices become more complex and powerful, they require more power and thus have low battery lives before recharging is needed. Thus, has also become mainstream for people to carry a charger in case there is an urgent need for recharging of the mobile device. While there are a wide variety of mobile chargers available, there is a need for an attractive, compact charger that can easily be carried by a user.

### SUMMARY

In one embodiment, a portable, adaptable universal mobile device charger is provided and configured to charge one or more electronic devices, such as, a mobile device (e.g., a smartphone, tablet, or a similar computer device) or other device that requires charging. The mobile device can be from any number of different suppliers and can be one of the following products: IPhone®, Android®, Blackberry®, Galaxy®, Droid® (but is not limited to only being used with such products). The size of this device is preferably no larger than a typical “jump drive”—very small in nature and attractive to all consumers worldwide.

The adaptable charger has a compact, aesthetic design that allows it to be easily contained and transported in a ladies small purse, man's pant pocket, backpack, shoulder bag, brief case, shirt pocket or the like. The adaptable charger is preferably constructed of a casing that contains the working components and electronics of the adaptable charger. The charger has a retractable cord inside which extends to connect to the mobile device and permits the mobile device to be a distance from the outlet. The charger is preferably light weight, can be offered in numerous colors and styles for men and women and be compatible with all industry smart devices.

The casing contains a foldable plug, at one end of the casing which is configured to pivot between open positions, to insert into a standard electrical 110 UV outlet, in a closed position where the foldable plug is received within a receiving space formed in the casing. At the opposite end of the casing is an extendable connector provided and is configured to attach to the mobile device for charging thereof.

The extendable connector can be at least partially countersunk in a recess formed in the casing such that only a portion or no portion protrudes from the end of the casing. Internally within the casing is an external winder cord (winder or retractable cord) that is attached to the extendable connector and to the internal electronics to allow the extendable connector to be extended from the casing to allow the mobile device to be charged some distance away from the casing when the foldable plug is inserted into the electrical outlet. The extendable connector can be configured to directly attach to the mobile device or can attach to a variety of different connector pieces that attach to different types of mobile devices, thereby allowing the adaptable charger to be used with universal electronic devices such as SMART phones, tablets, and/or similar smart devices.

An optional pouch can be provided in the form of a carrying case that comes with the charger to carry inside your briefcase, pocket or purse. It can be designed to zip or with a pull cord or like design. It is black and compact in design—discrete in size and can be offered in numerous colors and designs as well.

The present charger offers a number of advantages including, but not limited to, the following: minimal internal electronics are required—for charger itself and 110 UV outlet; compact size similar to the size of a traditional jump drive allows the unit to fit in a consumer's pocket; colorful, stylish case and optional pouch options offered to consumers.

### BRIEF DESCRIPTION OF THE DRAWING FIGURES

FIG. 1 is a side perspective view of a charger in accordance with one embodiment;

FIG. 2 is a side and end view of the charger of FIG. 1;

FIG. 3A is cross-sectional view of the charger of FIG. 1 showing an outlet plug in a retracted position;

FIG. 3B is a cross-sectional view of the charger of FIG. 1 showing the pivoting of the outlet plug;

FIG. 3C is cross-sectional view of the charger of FIG. 1 showing the outlet plug in a fully extended position;

FIG. 4 is a top and side perspective view of a charger in accordance with another embodiment;

FIG. 5 is a top and side perspective view of a charger in accordance with another embodiment;

FIG. 6A is a top and side perspective view of a charger in accordance with another embodiment;

FIG. 6B is a top and side perspective view of the charger of FIG. 6A in an extended position;

FIG. 7 is a top and side perspective view of a charger in accordance with another embodiment;

FIG. 8A is a first end view of the charger of FIG. 7;

FIG. 8B is a second end view of the charger of FIG. 7;

FIG. 9 is a partial end perspective view showing attachment of one connector;

FIG. 10 is a top and side perspective view of a charger in accordance with another embodiment with an extendable cord;

FIG. 11 is a top and side perspective view of a charger in accordance with another embodiment;

FIG. 12 is a side view of an optional pouch;

FIG. 13 is a front and top perspective view of a charger according to another embodiment;

FIG. 14 is a top plan view thereof;

FIG. 15 is a rear elevation view thereof;

FIG. 16 is a partial perspective view thereof showing internal components;

FIG. 17 is a side elevation view with a front housing part removed;

FIG. 18 is a side perspective view with a front housing part removed; and

FIG. 19 is a bottom plan view.

### DETAILED DESCRIPTION OF CERTAIN EMBODIMENTS

Provided herein, in accordance with the present invention, is an adaptable charger for charging one or more electronic devices, such as mobile device like a smartphone, etc. More specifically, the present invention comprises a charger with a compact, aesthetic design that is adaptable for charging various types of portable electronic devices. The figures appended hereto show variations of different chargers in accordance with the present invention.

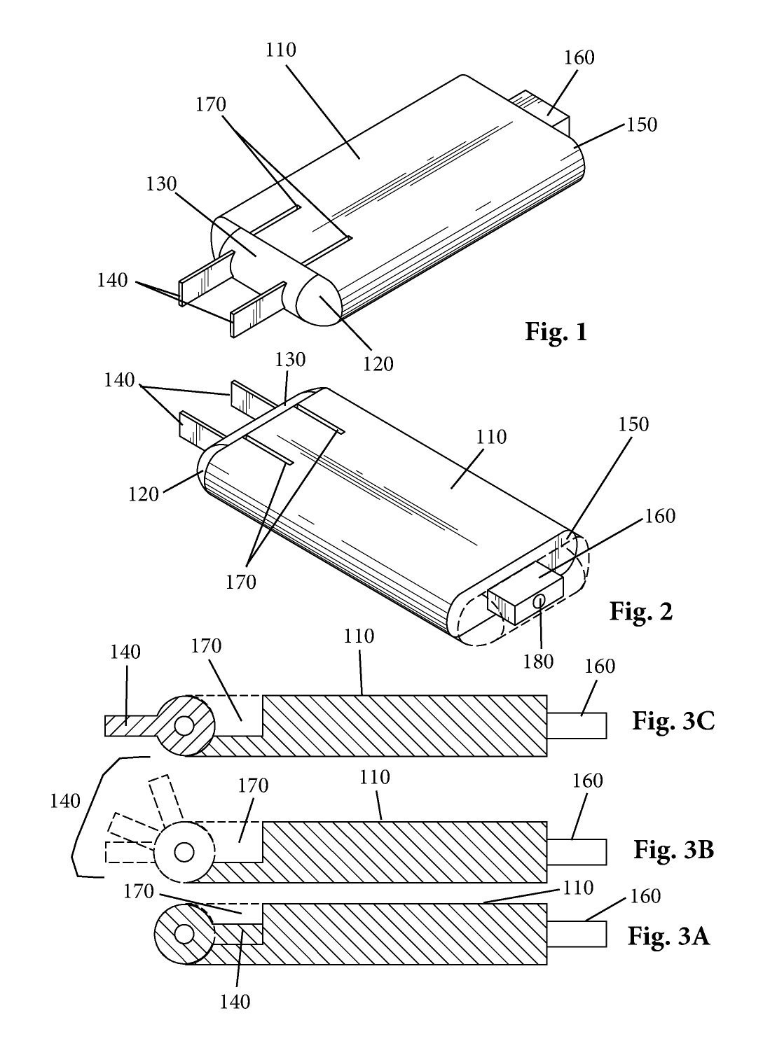

In general, the present invention encompasses four embodiments and several variations of those embodiments. For example, a winder cord (winder) can be located within the housing and attached to a connector of the charger in at least 2 embodiments (e.g., FIGS. 1, 2, and 4), such that the connector can extend completely outside of the housing of the charger when the winder is in an extended position. The winder thus allows for a connector to be movable to locations outside of the charger housing, thereby providing the charger with additional range for connecting with portable electronic devices. This and other advantages of the present invention will be appreciated in view of the following description.

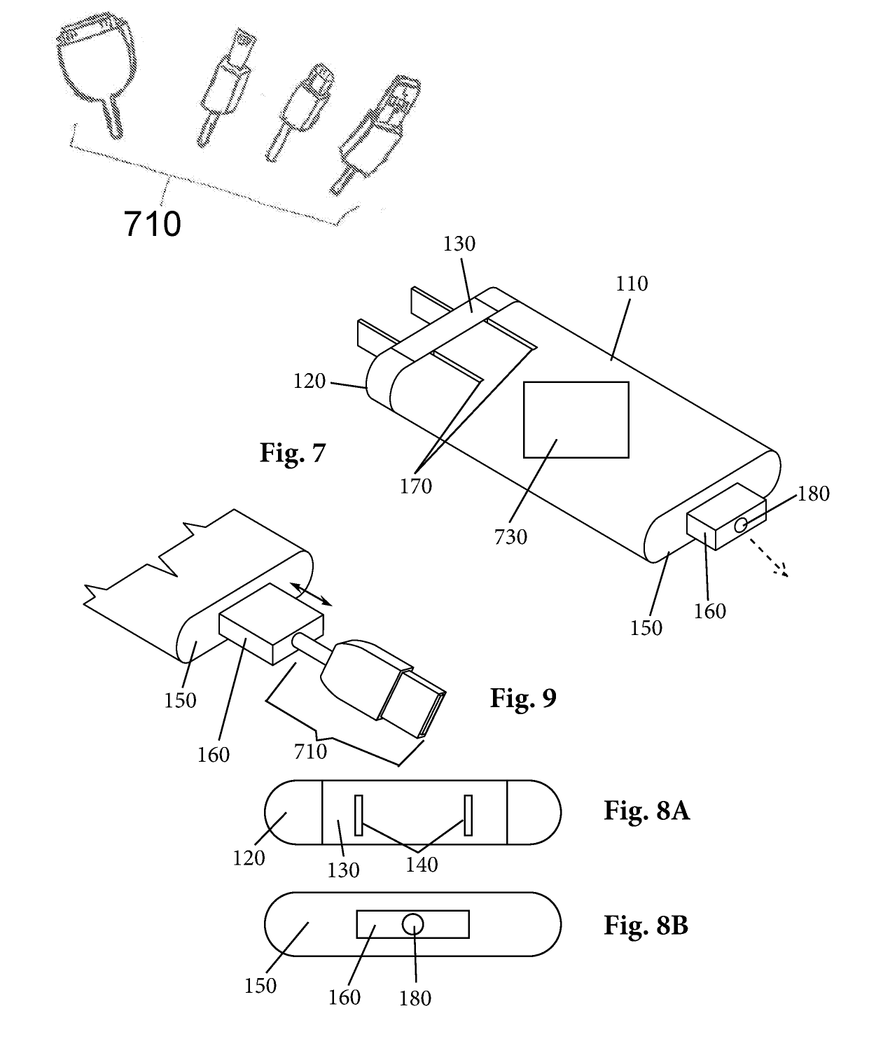

With reference to FIG. 1, in accordance with at least one variation, the charger comprises a housing 110 with a first end 120 containing a foldable plug 130 which comprises prongs 140, and a second end 150 containing a connector 160, wherein the connector 160 is electronically connected to the foldable plug 130 via electronics (e.g., a circuit board) within the housing 110. The housing 110 also comprises inlets 170 configured to receive the prongs 140 of the foldable plug 130 when the foldable plug 130 is in a fully disposed position (FIG. 3a [cross sectional view]). When the foldable plug 130 is in a partially extended position (FIG. 3b [cross sectional view]) or fully extended position (FIG. 3c [cross sectional view]), the foldable plug 130 via its prongs 140 is configured to connect to an electrical outlet, such as a wall socket. In one or more variations, the connector 160 is a female connector having an opening 180 (FIG. 2 and FIG. 7) configured for receiving any number of removable male connectors 710 (as shown in FIG. 7). For example, the removable attachment could be a male USB connector, configured for attachment to a mobile device capable of received a male USB connector. The various removable male connectors 710, as well as the fixed male and female connectors of various embodiments of the present invention, can be configured to connect to numerous types of portable electronic devices including but not limited to smart phones, tablets, e-books, music players, cameras, camcorders, gaming units, Bluetooth® headsets and earpieces, GPS devices and the like.

In one or more variations of the present invention, the connector 160 is a female connector configured to have an opening for directly receiving a male connector, such as a USB male connector, a fire wire male connector or other male connectors configured for attachment to various mobile devices. The male connector, for example, can be attached to a wire or a cord or a cable that is configured to connect to a portable electronic device. In one or more variations, the connector 160 is a male connector configured to attach to a female connector a portable electronic device.

It will also be understood that the connector 160 is not limited to a female connector but instead can be any type of fixed connector that is intended for direct attachment to a specific mobile device or the like.

In addition, the connectors described herein can have any number of different constructions and be of different types to accommodate different types of mobile device charging ports.

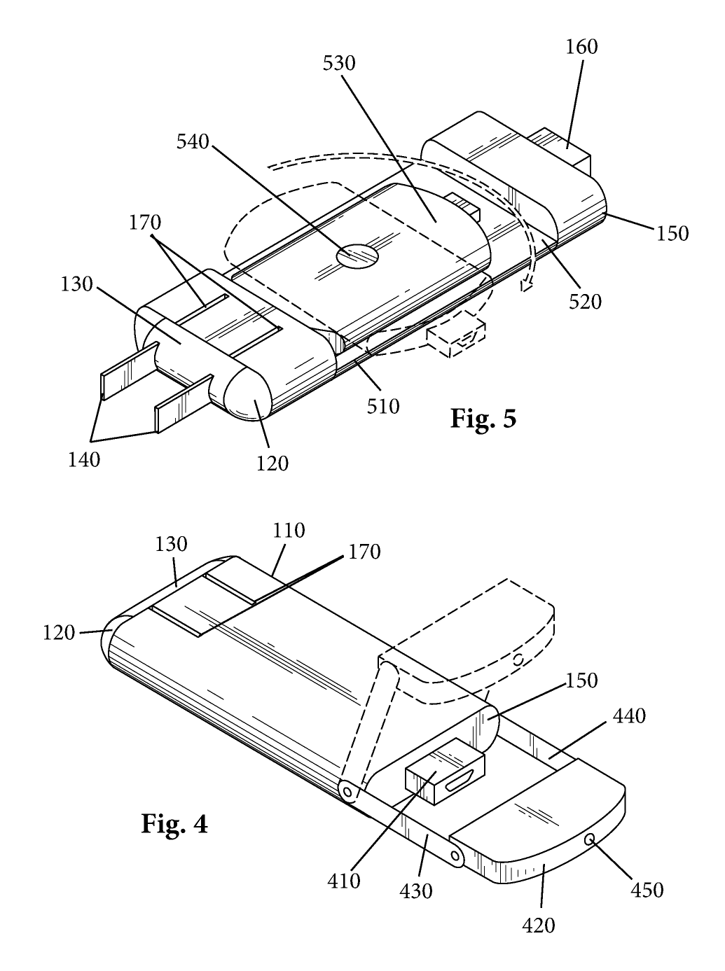

With reference to FIG. 4, in another variation the housing 110 can comprise a first connector 410 that is fixed to the second end 150, and a second connector 420 that is attached to the housing 110 via a first arm 430 and a second arm 440, and is configured to pivot to vertically and horizontally around the second end 150. Both the first connector 410 and the second connector 420 are electronically connected to the foldable plug 130 via electronics (e.g. circuit board) in the housing 110. The first connector 410 can be a female connector configured to receive a male connector that is electronically attachable to a portable electronic device (e.g., a Droid smartphone device or other smartphone). The second connector 420 can be a female connector having an opening 450 configured for receiving any number of removable male connectors 710 (as shown in FIG. 7) configured to be electronically attached to a portable electronic device. It will be understood that in one or more variations, either or both the first connector 410 and second connector 420 can be a male or a female connector configured to connect with a portable electronic device or a wire and/or cord and/or cable that is attachable to a portable electronic device. It will also be understood that either or both the first connector 410 and the second connector 420 can be a female connector having an opening configured for receiving any number of removable male connectors 710 (as shown in FIG. 7) configured to be electronically attached to a portable electronic device. In addition, both of the connectors 410, 420 can be of a fixed type intended for direct attachment to a specific type of mobile device.

In another variation, as shown in FIG. 5, the charger comprises a housing 510 with a first end 120 containing a foldable electric outlet plug 130 which comprises prongs 140, and a second end 150 that comprises a connector 160 that is fixed to the second end 150. The housing 510 also comprises inlets 170 configured to receive the prongs 140 of the foldable plug 130 when the foldable plug 130 is in a fully disposed (retracted) position. Additionally, the housing 510 comprises a recess or cavity 520 which comprises a swivel connector 530 anchored to said cavity 520 at a position 540 that is between the inlets 170 and the second end 150. The swivel connector 530 can be adapted to pivot horizontally such that part of the swivel connector 530 is outside of said housing 510. In at least one variation, the swivel connector 530 can pivot horizontally in either direction. In one or more embodiments, the swivel connector 530 can pivot in a range of greater than 0° to approximately 100° in either direction relative to the housing 510 (however these values are not limiting). Both the connector 160 and the swivel connector 530 are electronically connected to the foldable plug 130 via electronics (e.g. circuit board, transformer, etc.) contained in the housing 510. In particular, the transformer is a step-down transformer that steps down 110V (standard electric outlet) to 5V required for a typical mobile device.

It will be understood that in one or more variations, either or both the connector 160 and the swivel connector 530 can be a male or a female connector configured to connect with a portable electronic device or a wire and/or cord and/or cable that is attachable to a portable electronic device. It will also be understood that either or both the connector 160 and the swivel connector 530 can be a female connector having an opening configured for receiving any number of removable male connectors 710 (as shown in FIG. 7) configured to be electronically attached to a portable electronic device.

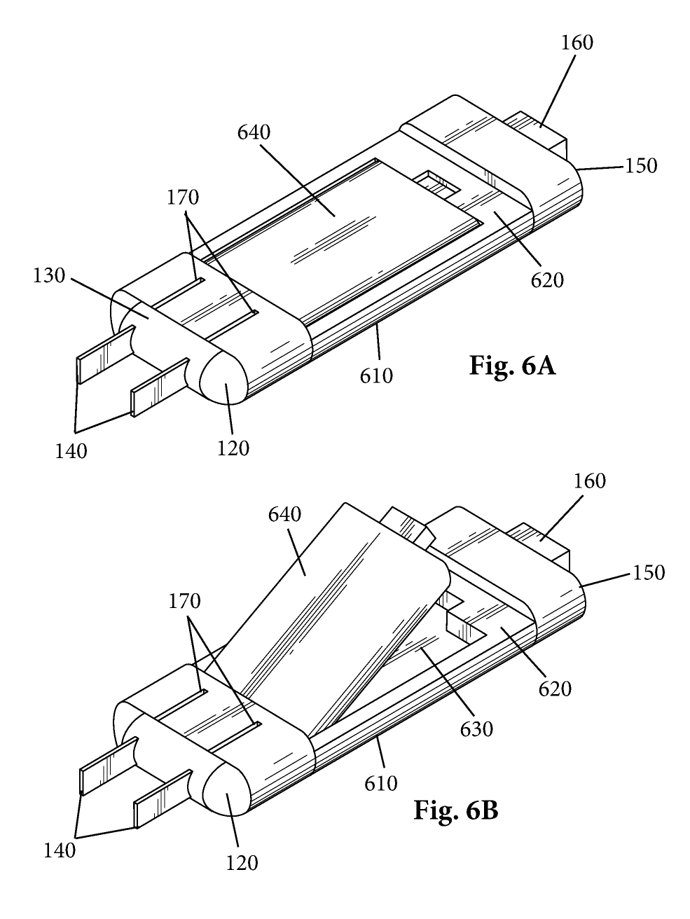

In another variation, as shown in FIGS. 6a and 6b, the charger comprises a housing 610 with a first end 120 containing a foldable plug 130 which comprises prongs 140, and a second end 150 that comprises a connector 160 that is fixed to the second end 150. The housing 610 also comprises inlets 170 configured to receive the prongs 140 of the foldable plug 130 when the foldable plug 130 is in a fully disposed (retracted) position. Additionally, the housing 610 comprises a first cavity 620 which comprises a second cavity 630 and a foldable connector 640 anchored to said second cavity 630 at a position 650 that is in between the inlets 170 and the second end 150. The foldable connector 640 can be adapted to pivot vertically to the outside of said housing 610. In at least one embodiment, the foldable connector 640 can pivot vertically in a range of greater than 0° to approximately 90° relative to the housing 610. FIG. 6a shows the foldable connector 640 in the full disposed position and FIG. 6b shows the foldable connector 640 in an extended position. Both the connector 160 and the foldable connector 640 are electronically connected to the foldable plug 130 via electronics (e.g. circuit board) in the housing 610.

It will be understood that in one or more variations, either or both the connector 160 and the foldable connector 640 can be a male or a female connector configured to connect with a portable electronic device or a wire and/or cord and/or cable that is attachable to a portable electronic device. It will also be understood that either or both the connector 160 and the foldable connector 640 can be a female connector having an opening configured for receiving any number of removable male connectors 710 (as shown in FIG. 7) configured to be electronically attached to a portable electronic device. Thus, the connectors 160, 640 can be any number of types of charging connectors.

FIG. 7 is cross sectional view of a variation of the embodiment shown in FIG. 2. In this variation (FIG. 7), a winder 720 is disposed within said housing 110 such that the winder is attached to the connector 160. The winder 720 provides an electronic connection between the connector 160 and the electronics 730 (e.g., circuit board) of the housing 110, the electronics 730 also being electronically connected to the foldable electric outlet plug 130. The winder 720 is configured to allow for the connector 160 to sit against the second end 150 of the housing 110 when the winder in a fully contracted position, and is configured to allow for the extension of the connector 160 completely outside of the second end 150 of the housing 110 when the winder 720 is in an partially or fully extended position. In at least one variation, as shown in FIG. 7, the winder 720 is configured to allow the connector 160 to be partially disposed within the second end 150 of the housing 110 when the winder 720 is in a fully contracted position.

In one variation, the connector 160 is partially disposed in the second end 150 of the housing 110 by seating against a shoulder formed in the opening formed at the second end 150. The distance between the peripheral shoulder and the second end is chosen such that a specific length of the connector 160 extends beyond the second end 150 for grasping by the user. Thus, the winder does not fully retract the connector 160 within the second end 150 such that the user cannot retrieve and move the connector 160 to the extended position. In addition, by being partially inserted into the second end opening, the stability of the connector 160 is increased in the event that the user plugs the connector 160 into a device or connects the connector to another connector such as a connector at the end of wire.

FIGS. 8a and 8b show front views consistent with the embodiments of at least FIGS. 1 and 2. FIG. 8a shows a front view of the first end 120 containing a foldable plug 130 which comprises prongs 140. FIG. 8b shows a front view of the second end 150 containing a connector 160, and having an opening 180.

FIG. 9 shows a prospective view consistent with the embodiments of at least FIGS. 1, 2, and 8b. FIG. 9 shows a removable male connector 710 attached to the connector 160 of the second end 150 via opening 180 (not shown).

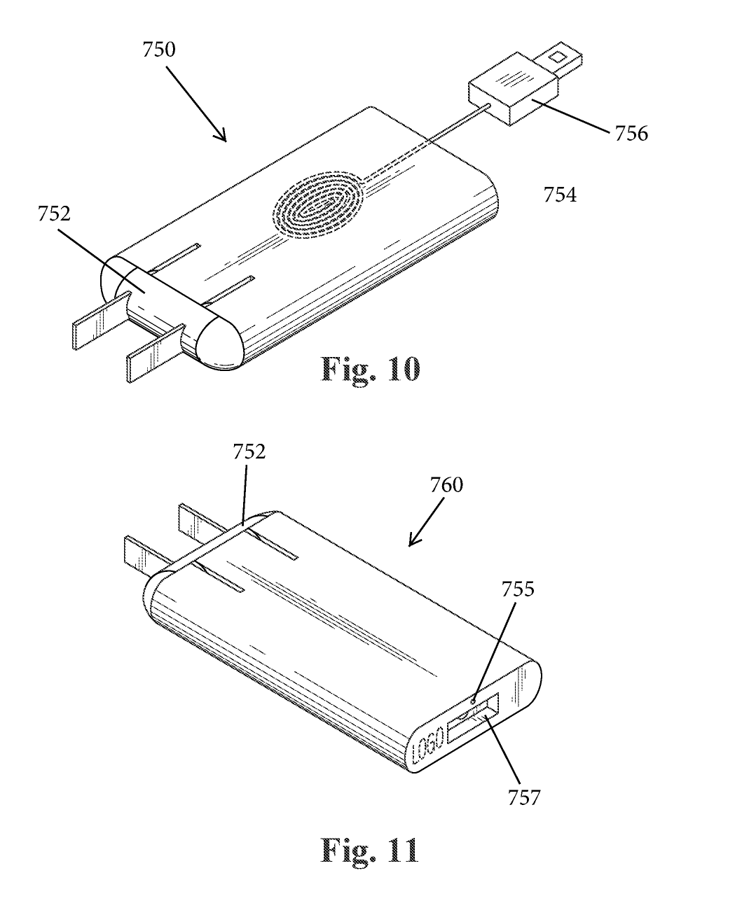

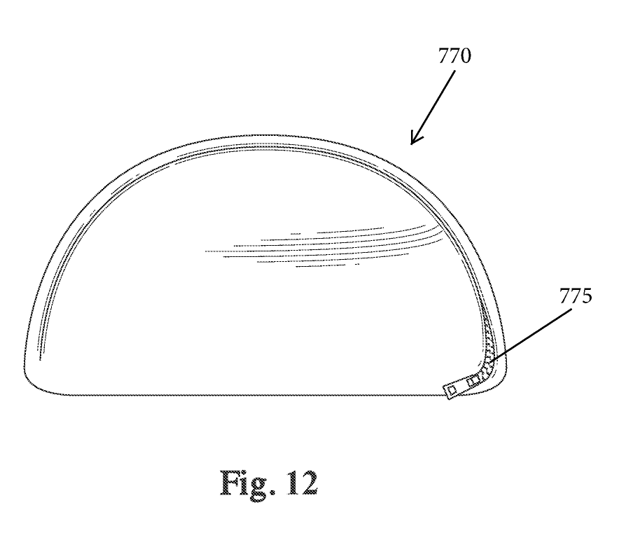

FIG. 10 shows a charger 750 that has a foldable plug 752 and an extendable/retractable cord 754 that terminates in a connector 756. FIG. 11 shows a charger 760 that has foldable plug 752 and has an indicator light 755 and a connector port 757 for attachment to 120 V devices. FIG. 12 illustrates a pouch (receptacle) 770 that can be used to contain any of the chargers disclosed herein and charger parts, including connector pieces 710. Pouch 770 can have a zipper 775 or other fastener, such as hook and loop material to close the pouch. A bag, such as a drawstring bag, can likewise be used.

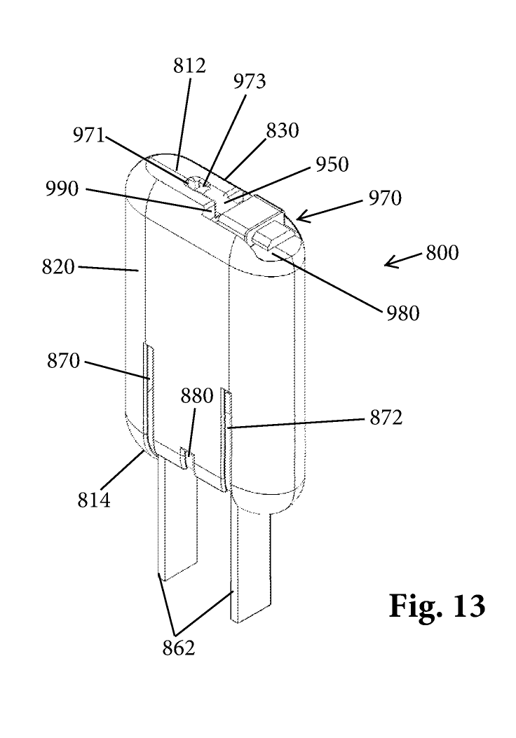

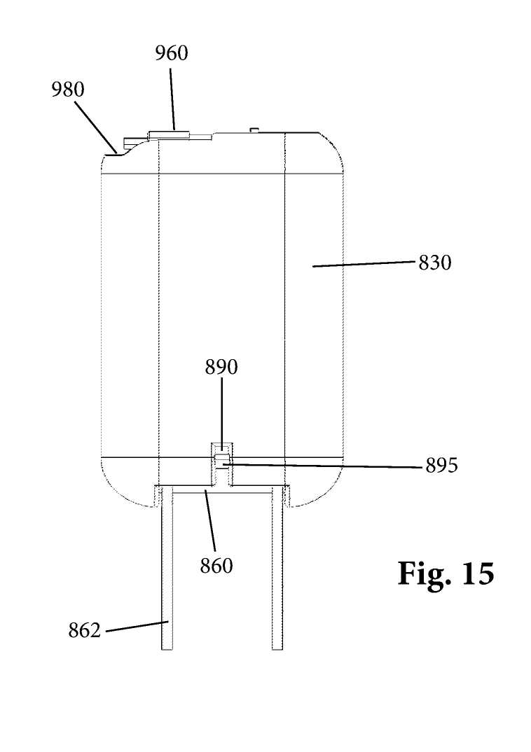

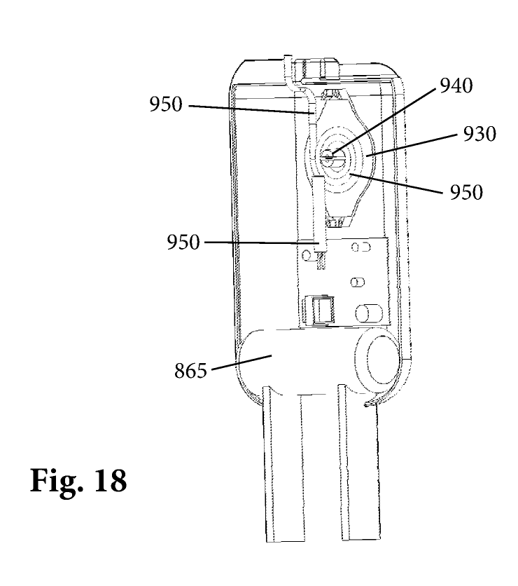

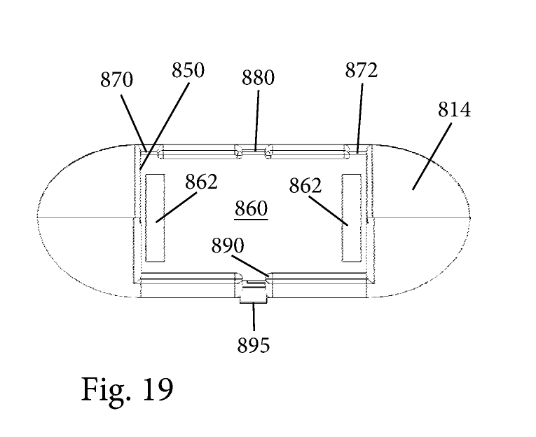

FIGS. 13-19 illustrate a charger 800 in accordance with another embodiment. Charger 800 shares some similarities with chargers previously described.

The charger 800 includes a housing (casing) 810 which can be formed of a plurality of parts, such as a front part 820 and a rear part 830 that are attached to one another using conventional means, such as mechanical attachment, snap-fit, and/or the use of fasteners. The assembled front and rear housing parts 820, 830 define an internal compartment (cavity) 840 in which a number of the working components of the charger 800 are contained as described herein. The housing can have curvature along its sides (as shown) or can have a rectangular footprint thereby increasing the size of the internal compartment 840.

The housing 810 has a first end 812 and an opposing second end 814, a front surface 816, and a rear surface 818. In the illustrated embodiment, each of the front housing part 820 and the rear housing part 830 extends from the first end 812 to the second end 814 and thus, each part generally defines one half of the housing. The housing 810 is preferably formed of a molded plastic; however, other material can be used.

At the second end 814, an opening 850 is formed to accommodate a foldable plug 860. The opening 850 can take any number of different shapes so long as the foldable plug 860 can freely pivot therein and prongs 862 of the plug 860 can pass through the opening 850. The illustrated opening 850 has a rectangular shape. The front housing part 820 includes a pair of spaced slots 870, 872 that communicate with and are open, at ends thereof, to the opening 850. These slots 870, 872 are sized to receive the prongs 862 when the foldable plug 860 is in its retracted position (similar to what is shown in FIG. 4). The front housing part 820 also include another slot or notch 880 that is formed between the slots 870, 872 and is much smaller size.

The rear housing part 830 also includes a slot or notch 890 that opens into the opening 850. Slots 880, 890 are complementary and are aligned with one another.

The plug 860 has a base portion 865 from which the prongs 862 extend. Base portion 865 is pivotally contained within the housing 810 such that base portion 865 rotates within the housing 810 between an extended position (shown) and a retracted position. The plug 860 includes a tab 895 that extends outwardly therefrom and is sized to be received within either slot 880 or slot 890 depending upon the position of the plug 860. In other words, when the plug 860 is in its retracted position and the prongs 862 are in slots 870, 872, the tab 895 will be contained within the slot 880 between slots 870, 872. Conversely, as shown, when the plug 860 is fully extended (in use position), the tab 895 is contained in slot 890. The tab 895 permits the user to easily move the plug between the extended and retracted positions and thus, is designed to be grasped and manipulated by the user to cause pivoting of the plug 860 in the housing 810.

As with previous embodiment described herein, the charger 800 includes an extendable cord/connector. Within internal compartment 840 are traditional charger electronics, such as one or more printed circular boards 841, a capacitor, and other electrical components, such as an integrated circuit, transformer coils, soldered connections, etc. The electronics are securely mounted within the internal compartment 840.

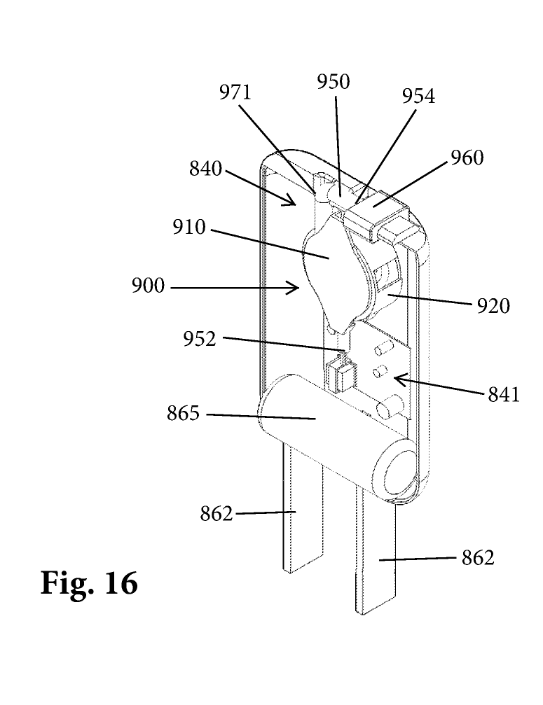

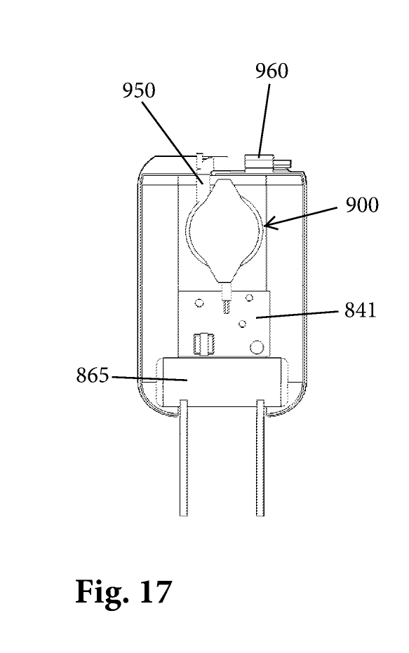

As shown in FIGS. 16-17, charger 800 also includes a winder 900 that is disposed within the internal compartment 840 of the housing 810 such that the winder is attached and mounted to the housing 810. The winder 900 can include a cover 910 and a casing 920. The winder 900 also includes a spring base 930 that has a post 940 protruding therefrom. The winder 900 is spring biased and is in the form of a cable (recoil) winder about which a cable is wound. The casing 920 and cover 910 are positioned over the post 940 and spring base 930.

The charger 800 includes a cable 950 that has a first end 952 that is in electrical connection with the electronics so as to provide an electrical connection between the plug 860 and the cable 900. The first end 952 can thus have a soldered connection to a component of the electronics. The cable 950 includes an insulated cover (jacket) that protects the actual wires of the cable 950. For ease of illustration, portions of the outer jacket have been removed in the figures to show internal wires (e.g., at a location about the post 940). The cable 950 has a second end 954 which is electrically connected to a connector 960 (connector component). The cable 950 is routed through the winder 900 such that in the retracted position, the cable 950 is coiled about the post 940 and in the extended position, the cable 950 is unwound from the post 940. The winder is designed to maintain the cable 950 under tension and can include a conventional locking mechanism to maintain the cable 950 in a user selected extended position at a user selected length. For example, the user can tug the cable 950 to release the locked position and cause retraction of the cable 950 (i.e., the cable 950 is wound about the winder).

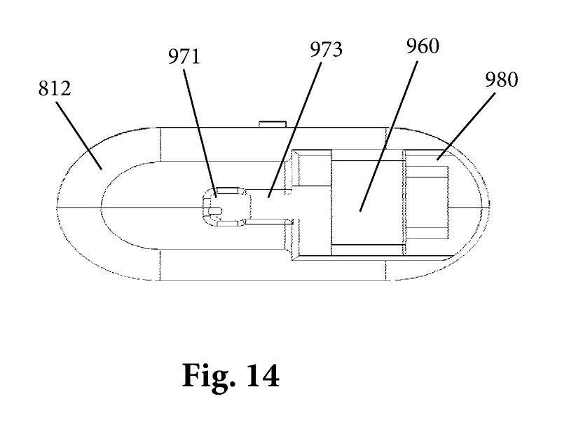

The first end 812 of the charger 800 is configured to receive and hold the connector 960 and distal end portion of the cable 950 in an at least partially and preferably fully recessed manner. More specifically, the front and rear housing parts 820, 830 are configured to include a recessed compartment or cavity generally shown at 970. As shown in the figures, the cavity 970 is formed within one end portion of the housing 810 as shown in FIGS. 13-14. The first end 812 includes an opening 971 which defines a passageway to the internal compartment of the housing 810 and provides the means by which the cable 950 exits the internal compartment of the housing 810 and is accessible to the user. The opening 971 opens into a first recessed portion 973 which in turn opens into a second recessed portion 980. The second recessed portion 980 is accessible laterally in that the second recessed portion 980 extends to one side of the first end 812 to allow the user to laterally access the connector 960. Both the first and second recessed portions 973, 980 are defined by a floor and a pair of side walls. As shown in the figures, the first recessed portion 973 is narrower than the second recessed portion 980 and in particular is configured to receive the cable 950 but not the connector 960. Conversely, the second recessed portion 980 is configured to receive the connector 960 and the cable 950. A shoulder (wall) 990 is formed between the first and second recessed portions 973, 980.

When the winder applies a recoil force to the cable 950 and the connector 960, the cable 950 is pulled through the opening 971 and is wound about the winder and the connector 960 is pulled into the second recessed portion 980 against the shoulder 990 which acts as a stop. Within the first and second recessed portions 973, 980, the cable 950 and connector 960 lies, in a longitudinal direction, at least generally parallel to the floor of the first and second recessed portions 973, 980. The cable 950 and connector 960 can lies flush against the floor of the first and second recessed portions 973, 980. The side walls of the second recessed portion 980 are spaced so that there is slight clearance between these side walls and the connector 960. To provide access to the connector 960, the side walls of the second recessed portion 980 taper downward as shown in the figures such that the one side of the first end 812 does not include a wall that extends upwardly from the floor of the second recessed portion 980 and thus, the user can place a finger into the second recessed portion 980 to contact and grasp the connector 960.

Once the user grasps the connector 960, the user can pull the connector 960 laterally so that the connector 960 and attached cable 950 are removed from the second recessed portion 980 and the cable 950 can be unwound to the desired length.

It will also be understood that the opening 971 can be defined by a sloped surface as opposed to a sharper angle as in the figure. In other words, a curved surface can define the opening 971 and provide an entrance to the first recessed portion 973. The cable 950 thus travels from the winder along this curved surface to the first recessed portion 973 where it extends across the floor thereof.

Once the user actuated the winder to cause a recoil action, the cable 950 is pulled back through the opening 971 and is wound about the winder and this results in the connector 960 being drawn laterally back into the second recessed portion 980 until it seats against the shoulder 990 (which stops the retraction of the cable and connector 960). It will also be understood that the connector 960 can be a specific type of connector for one type of mobile device or similar to what is shown in FIG. 7, the connector 960 can be a first connector part, like part 160, that mates with a second connector part, like connector parts 710, to form a connector. Depending upon the type of mobile device that is to be charged, the user thus selects the appropriate second connector part that mates (e.g., female and male connection) with the first connector part. In this construction, the connector 960 can be extended and then mated with a complementary second connector piece designed to mate with the charging port of the mobile device.

By at least partially and preferably fully recessing the connector 960 at the first end 812, the charger 800 is made very compact since the cable 950 and connector 960 are not free to dangle distally beyond the first end 812 where it can become damaged or entangled with other objects when placed in a purse or the like.

The charger 800 can be formed to have different shapes and sizes and preferably has a size that is similar to a flash drive. In one embodiment, the charger 800 can have a width of about 1 inch (or smaller); a height of about ½ inch (or smaller); and a length of about 2¼ inch (or smaller). In another embodiment, the charger 800 has a width of about 1⅜ inch; a height of about ¾ inch and a length of about 2¼ inch.

It will therefore be appreciated that the various connectors shown herein include one or more connectors that are designed to provide an electronic connection between the charger and another part, such as another connector (at the end of wire) or a mobile device, etc. The designs offer compact designs that are attractive yet versatile and provide in some variations, at least two connectors that are set forth in a compact footprint and allow the user to charge multiple devices at one time. It will be appreciated that in the variations that include two connectors, the two connectors can be used in some of the designs at one time, whereby multiple devices can be charged.

The chargers can also include additional components, such as attachment points for a lanyard and also can include in some designs, a light source, such as an LED.

Notably, the figures and examples above are not meant to limit the scope of the present invention to a single implementation, as other implementations are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an implementation showing a singular component should not necessarily be limited to other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific implementations will so fully reveal the general nature of the invention that others can, by applying knowledge within the skill of the relevant art(s) (including the contents of the documents cited and incorporated by reference herein), readily modify and/or adapt for various applications such specific implementations, without undue experimentation, without departing from the general concept of the present invention. Such adaptations and modifications are therefore intended to be within the meaning and range of equivalents of the disclosed implementations, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various implementations of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary implementations, but should be defined only in accordance with the following claims and their equivalents.

What is claimed:

1. A charger for a mobile device comprising:
a housing having a first end, a second end, a hollow interior compartment, the second end including a first opening and a pair of first slots that accommodate a foldable plug that is disposed within the hollow interior compartment and is pivotally coupled to the housing, the foldable plug being movable between an extended position in which prongs thereof lie outside of the housing and a fully retracted position in which the foldable plug lies within the pair of first slots;
electronics contained within the housing;
a spring biased winder mounted to housing and disposed within the hollow interior compartment;
an extendable/retractable cord that is connected at one end to a connector and at an opposite end is electrically connected to the foldable plug and is wound about the spring biased winder;
wherein the first end of the housing includes an opening that is in communication with the hollow interior compartment and defines a passage through which the cable passes, the first end of the housing also including a first recessed portion in direct communication with the opening and second recessed portion that is in direction communication with the first recessed portion, the first recessed portion having a width that is less than a width of the second recessed portion so as to form a shoulder therebetween, wherein in a fully retracted position, a distal end portion of the cable is seated within the first recessed portion and the connector is seated within the second recessed portion and is oriented in a plane that is at least substantially parallel to a plan containing a floor of the second recessed portion.

2. The charger of claim 1, wherein the connector is completely contained within the second recessed portion.

3. The charger of claim 2, wherein a top surface of the connector lies recessed relative to an end surface of the housing at the first end.

4. The charger of claim 1, wherein the opening is defined by a curved surface that forms an entrance into the first recessed portion.

5. The charger of claim 1, wherein the foldable plug includes a user accessible tab and the housing includes a second slot formed on one side face of the housing and a third slot formed on an opposite side face of the housing, wherein when the foldable plug is in the extended position, the tab lies in the second slot and in the fully retracted position the tab lies in the third slot.

6. The charger of claim 5, wherein the third slot is formed between the pair of first slots.

7. The charger of claim 1, wherein in the fully retracted position, the connector lies against a floor of the second recessed portion.

8. The charger of claim 1, wherein in the fully retracted position, the winder applies a biasing force to the cable and connector causing the connector to remain seated within the second recessed portion against the shoulder.

9. The charger of claim 1, wherein the shoulder is perpendicular to a floor of each of the first and second recessed portions.

10. The charger of claim 1, wherein the connector comprises a female connector piece that is configured to mate with a selected male connector piece that is configured to mate with a charging port of the mobile device.

11. The charger of claim 1, wherein the housing has planar front and rear surfaces and curved side walls connecting the planar front and rear surfaces.

12. The charger of claim 1, wherein the first end is open along one side thereof to allow lateral access to the connector and permit lateral removal of the connector.

13. The charger of claim 1, wherein the housing has a sloped surface between the winder and the first recessed portion over which the cable travels through the opening.

14. The charger of claim 1, wherein the foldable plug has a cylindrical base portion that is rotatable within the hollow interior compartment.

15. The charger of claim 1, wherein a height of the second recessed portion is greater than a height of the connector resulting in the connector being disposed in a countersunk manner in the second recessed portion.

16. The charger of claim 1, wherein the second recessed portion is defined by a pair of parallel side walls, the pair of side walls being discontinuous so as to define tapered ends proximate one side of the first end of the housing.
